(19) United States
(12) Patent Application Publication
(10) Pub. No.: US 2004/0042125 A1
(43) Pub. Date: Mar. 4, 2004

(54) Mounting method of magnetic head on rotary cylinder and rotary magnetic head

(75) Inventor: Kiyoshi Matsui, Osaka (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/650,781

(22) Filed: Aug. 29, 2003

(30) Foreign Application Priority Data
Sep. 3, 2002 (JP) 2002-258185

(51) Int. Cl. G11B 5/52

(52) U.S. Cl. 360/271.5

(57) ABSTRACT

In a rotary magnetic head, two pairs of video head core bars for Rch and Lch (R1, L2, R2, L1) forming a gap are fabricated, and the video core bars are arranged face up and back (R1 and R2 are faced, L2 and L1 are back). The direction of each gap is inclined by 6 degrees to a direction perpendicular to the slice line, and the reference height position of the gap of 2nd bar is set higher by a specified amount from the reference height position of the gap of 1st bar, and is fixed. By cutting out the video core bars simultaneously, two pairs of head cores optimized in the height of the reference position of the gap from the cutting-out surface are formed. By adhering the cutting-out surfaces of the head cores to a common base, the cores are positioned at a desired height, and core height adjusting mechanism is not needed.

### BACKGROUND OF THE INVENTION

1. Field of the Invention

The present invention relates to a mounting method of a magnetic head for recording and/or reproducing information in a recording medium such as magnetic tape on a rotary cylinder, and a rotary magnetic head having a magnetic head mounted by the same method.

2. Description of the Related Art

Hitherto is known a VCR (video cassette recorder) comprising a rotary magnetic head for recording and/or reproducing information magnetically in a magnetic tape. FIG. 22 and FIG. 23 show a general structure of rotary magnetic head of two-head type. A rotary magnetic head 70 includes a stationary cylinder 71, a rotary cylinder 74 which is rotated and driven by a rotary drive mechanism (not shown) by way of a shaft 72 and a bearing 73, and two magnetic heads 80a, 80b mounted on the rotary cylinder 74. The two magnetic heads 80a, 80b are adhered to metal bases 91a, 91b, and these bases 91a, 91b are fastened to the rotary cylinder 74 by way of mounting screws 92a, 92b, and hence they are mounted at 180-degree opposite positions across the shaft 72 of the rotary cylinder 74.

The magnetic heads 80a, 80b are composed of head cores 81a, 81b and coil windings 82a, 82b surrounding them, and the head cores 81a, 81b have gaps 84a, 84b for generating magnetic flux provided at their leading ends 83a, 83b, and the leading ends 83a, 83b project from the outer circumference of the stationary cylinder 71 and rotary cylinder 74 by about 40 μm. The gap 84a and gap 84b are inclined by a specified angle (azimuth angle) θ in mutually opposite directions in order to avoid crosstalk (interference) from adjacent recording tracks.

In order to record and/or reproduce appropriately by the gap 84a and gap 84b, a high precision is required in positioning of relative height of the gaps 84a, 84b to the rotary cylinder. However, conventional head cores 81a, 81b were fabricated, for example, by preparing a core bar for head cores by adhering a C-shape core bar and an I-shape core bar, and cutting out by a wire saw. Accordingly, depending on the precision of cutting process, the height dimension of the gaps 84a, 84b from the cutting section varied in each head core, and it was difficult to position the relative height of the gaps 84a, 84b accurately.

In the rotary magnetic head 70, hence, it is designed to adjust the mounting height of the head cores 81a, 81b by pressing the bases 91a, 91b by height adjusting screws 97a, 97b. The height adjusting screws 97a, 97b are screws for pressing the bases 91a, 91b in the reverse direction of the fastening direction of the bases 91a, 91b by the mounting screws 92a, 92b, and by tightening or loosening the height adjusting screws 97a, 97b, the relative angle of the bases 91a, 91b to the rotary cylinder 74 is adjusted, so that the relative height position of the gaps 84a, 84b with respect to the rotary cylinder 74 is adjusted.

The head cores 81a, 81b are polished at the leading ends facing the bases 91a, 91b to which the head cores 81a, 81b are adhered, and are mounted on the rotary cylinder 74 by way of the bases 91a, 91b. The bases 91a, 91b are mounted on the rotary cylinder 74 by adjusting the projecting amount of the leading ends of the head cores 81a, 81b from the outer circumference of the rotary cylinder 74.

In other prior art, a rotary magnetic head comprises a plurality of head support substrates on which head cores are mounted, a common support substrate common to every two head support substrates fastened with screws, and height adjusting screws for adjusting the relative angle of the head support substrate to the common support substrate and adjusting the height position of the magnetic head (for example, see Japanese Laid-Open Patent Publication No. SHO 59-144029). A different example is a rotary magnetic head comprising a magnetic head, a flexible seat rotatably supported on a rotary shaft, and a back plate disposed across a tiny gap at the lower side of the flexible seat (for example, see Japanese Laid-Open Patent Publication No. SHO 54-92212). A further different example is a rotary magnetic head comprising a head disk on which a magnetic head is mounted, and mounting screws for mounting this head disk on the flange of a rotary shaft (for example, see Japanese Laid-Open Patent Publication No. SHO 55-77051).

### SUMMARY OF THE INVENTION

In these conventional rotary magnetic heads, however, since the head cores 81a, 81b cannot be cut out at high precision, a head core height position adjusting mechanism by bases 91a, 91b, mounting screws 92a, 92b, and height adjusting screws 97a, 97b is needed, and the structure of the apparatus is complicated and the assembling process cannot be simplified. Similarly, in the rotary magnetic head disclosed in the publication No. SHO 59-144029, the head support substrate for mounting the magnetic head and the height adjusting screws for adjusting the height position of the magnetic head are required, and the structure is complicated and the assembling process cannot be simplified. If the head cores are directly mounted on the rotary cylinder by omitting the height adjusting mechanism of the head cores, and if the head cores can be processed at high precision, polishing of the leading ends of head cores must be done in the thin single body of each head core, and it is hard to execute.

In the rotary magnetic heads disclosed in the publications No. SHO 54-92212 and No. SHO 55-77051, the head cores cannot be processed at high precision, and it is hard to adjust the relative height of each magnetic head core accurately.

The invention is intended to solve these problems, and it is hence an object thereof to present a mounting method of magnetic head on rotary cylinder and a rotary magnetic head, simplified in structure and assembling process, by enhancing the processing precision of magnetic head cores, mounting each head core on a common mounting base in the height position adjusted position of each head core, and omitting the conventional height adjusting mechanism of head cores.

To achieve the object, the invention presents a method of mounting magnetic heads on a rotary cylinder, in a rotary magnetic head comprising a rotary cylinder, a mounting base mounted on this rotary cylinder, and magnetic heads for right channel and left channel provided at 180-degree opposite positions across the center of rotation on the mounting base, comprises: a core bar fabricating step of forming bar-shaped core bars having gaps for generating magnetic flux, a core fabricating step of forming head cores by fixing two core bars formed in said core bar fabricating step as one pair by arranging the two core bars in an oblique direction with the corresponding positions of the gaps matched at said specified angle, and cutting out these core bars in a thickness unit of one head core in an oblique direction at said specified angle, a head core holding step of matching the relative height positions of the gaps by holding the head cores fabricated at said core fabricating step in a core fixing jig, a head mounting step of mounting said head cores held at said head core holding step on a mounting base common to both head cores, and a base mounting step of mounting said mounting base on which said head cores are mounted at said head mounting step on said rotary cylinder.

According to this manufacturing method, the height position of each head core from the gap cutting-out surface exactly corresponds to the mounting height of each magnetic head. Therefore, while matching the height position of the cutting-out surface, by mounting each head core on a mounting base, the relative height positions of the head cores are mutually optimized. In addition, since two core bars are cut out in a state arranged and fixed in an oblique direction reversely in upward and downward directions, each core has a gap in an oblique direction opposite each other to the cutting-out surface, so that head cores for right channel and left channel are formed at the same time.

Preferably, the method of mounting magnetic heads on a rotary cylinder further comprises: a core polishing step of polishing the leading ends of the head cores by pressing a polisher to the leading ends of the head cores while rotating said mounting base on which said head cores are mounted at said head mounting step.

In this manufacturing method, all distances are in the same dimension from the center of rotation of the mounting base to the leading end of each head core after polishing, and it is easy to adjust the projection amount of the head core leading end from the rotary cylinder in the base mounting process.

The invention also presents a method of mounting said video heads and audio heads on a rotary cylinder, in a magnetic head comprising a rotary cylinder, a mounting base mounted on this rotary cylinder, each pair of video heads for right channel and left channel provided at 180-degree opposite positions across the center of rotation on said mounting base, and each pair of audio heads for right channel and left channel provided at 180-degree opposite positions across the center of rotation on the mounting base, comprises: a core bar fabricating step of forming video core bars and audio core bars having gaps between them by adhering bar-shaped C-shape core bar and I-shape core bar, a video core fabricating step of forming two pairs of video head cores by fixing two video core bars formed in said core bar fabricating step as one pair by arranging the two pairs, with the two video core bars face up and down, in an oblique direction with the corresponding positions of the gaps matched at said specified angle, and cutting out these two pairs of video core bars in a thickness unit of one video head core in an oblique direction at the specified angle, an audio core fabricating step of forming one pair of audio head cores by fixing two audio core bars formed in said core bar fabricating step as one pair, with the two audio core bars face up and down, in an oblique direction with the corresponding positions of the gaps matched at said specified angle, and cutting out the pair of audio core bars in a thickness unit of one audio head core in an oblique direction at the specified angle, a core height adjusting step of adjusting the relative height positions of gap of said video head cores and gap of said audio head cores, by holding the two pairs of video magnetic head cored formed at said video core fabricating step by a video head core fixing jig, holding the pair of audio head cores formed at said audio core fabricating step by an audio head core fixing jig slidable in a direction perpendicular to the cutting-out surface of said video head cores, and sliding the audio head core fixing jig, a head adhering step of adhering said video head cores and said audio head cores of which relative height positions of gaps are adjusted at said core height adjusting step, on a mounting base common to the head cores, a core polishing step of polishing the leading ends of the head cores by pressing a polisher to the leading ends of the head cores while rotating the mounting base on which said video head cores and said audio head cores are adhered at said head adhering step, and a base adhering step of adhering said mounting base on said rotary cylinder after winding a coil winding on each said head core polished at said core polishing step.

According to this manufacturing method, two pairs of video core bars are cut out simultaneously, and two pairs of head cores mounted on one rotary head are fabricated in a same thickness. Herein, since each video core bar is cut out in an arranged and fixed state by matching the corresponding position of each gap at the cutting-out angle, the height position of each video head core from the gap cutting-out surface accurately corresponds to the mounting height of each magnetic head. Therefore, by mounting each video head core on the mounting base while matching the height position of the cutting-out surface, the relative height position of each video head core can be optimized. In each video head core, a gap is formed in an oblique direction facing each other to the cutting-out surface, and hence the two pairs of video head cores for right channel left channels are formed simultaneously. One pair of audio head cores are also cut out and formed simultaneously in a same thickness in an arranged and fixed state by matching the corresponding position of each gap at the cutting-out angle.

The video head and audio head formed in this way are fixed on a video head core fixing jig and an audio head core fixing jig, and adhered to a mounting base common to each head core. At this time, a relative height position of gaps of video head cores is optimized. Similarly, a relative height position of gaps of audio head cores held in the audio core fixing jig is also optimized. By sliding of the audio core fixing jig, the relative height position of the gap of each video head core and gap of each audio head core is adjusted, and all magnetic head cores are adhered to the mounting base in a height position optimized state. All distances are in the same dimension from the center of rotation of the mounting base to the leading end of each head core after polishing, and it is easy to adjust the projection amount of the head core leading end from the rotary cylinder in the base mounting process.

The invention further presents a rotary magnetic head for VCR comprises: a rotary cylinder, a mounting base adhered to said rotary cylinder, each pair of video heads for right channel and left channel formed at 180-degree opposite positions across the center of rotation of said mounting base, each pair of audio heads for right channel and left channel formed at 180-degree opposite positions across the center of rotation of said mounting base, and a rotary cylinder on which said video heads and audio heads are mounted by way of said mounting base, wherein said video heads and audio heads respectively form a gap between them by adhering C-shape core and I-shape core, and video head cores and audio head cores are adhered to the mounting base common to the head cores, with the relative height positions of gaps being adjusted.

In this configuration, the mechanism for adjusting the height position of each head core is not needed.

### BRIEF DESCRIPTION OF THE DRAWINGS

FIG. 1 is a sectional view showing a structure of rotary magnetic head in an embodiment of the invention.

FIG. 2A is a bottom view showing the mounting position of magnetic head cores in the rotary magnetic head, and FIG. 2B is an upside down side view thereof.

FIG. 3 is a magnified side view of head core.

FIG. 4 is a diagram showing a relative configuration of head cores and effective track width.

FIG. 5 is a magnified side view of mounting portion of head cores on a common base.

FIG. 6A is a side view of video magnetic head core, FIG. 6B is a plan view of head core, and FIG. 6C is a magnified view of FIG. 6A.

FIG. 7 is a perspective view of video core bar.

FIG. 8 is a perspective view showing C-shape core bar and I-shape core bar.

FIG. 9 is a side view showing groove processing mode of C-shape core bar and I-shape core bar.

FIG. 10 is a diagram showing C-shape core and I-shape core when the groove processing position is deviated.

FIG. 11 is a side view showing arrangement of video core bars when cutting out video head cores.

FIG. 12 is a plan view showing arrangement of video core bars and slice position when cutting out video head cores.

FIG. 13 is a diagram showing the reference height position of gaps and effective track width of head cores fabricated in head core fabricating process.

FIG. 14 a diagram showing reference height position of gap of each magnetic head core relative to common base.

FIG. 15 a bottom view of head core fixing jig holding head cores.

FIG. 16 is a sectional view of B-B in FIG. 15.

FIG. 17 is a sectional view showing an audio head core fixing jig holding audio head cores.

FIG. 18 is a sectional view of C-C in FIG. 15.

FIG. 19 is a bottom view of polishing mode of leading end of magnetic head core by polishing tape.

FIG. 20 is a magnified side view of leading end of the head core.

FIG. 21 is a side view of a wired common base on which a printed circuit board is mounted.

FIG. 22 is a sectional view showing a structure of a conventional rotary magnetic head.

FIG. 23A is a bottom view showing mounting state of a conventional magnetic head on a rotary cylinder, and FIG. 23B is a magnified view of the magnetic head.

### DESCRIPTION OF THE PREFERRED EMBODIMENT

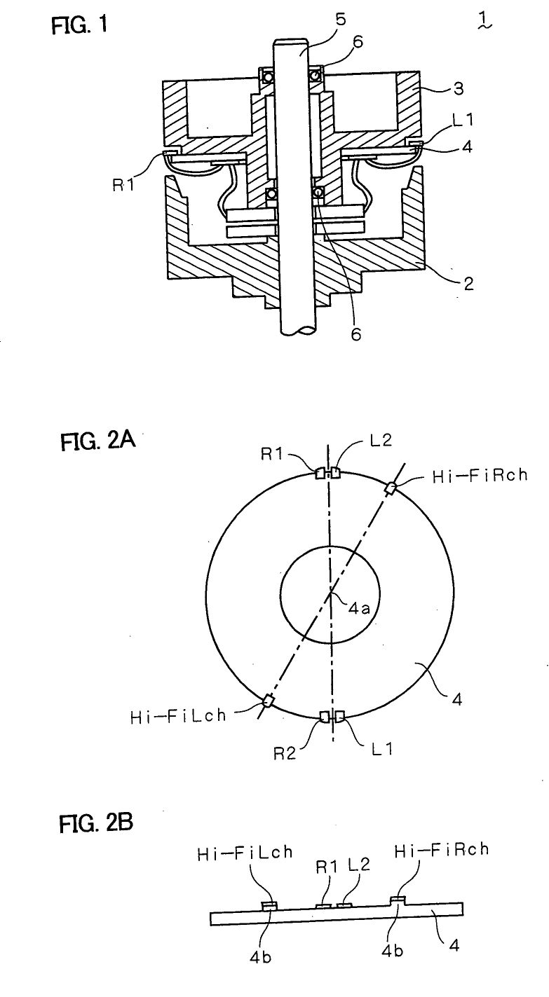

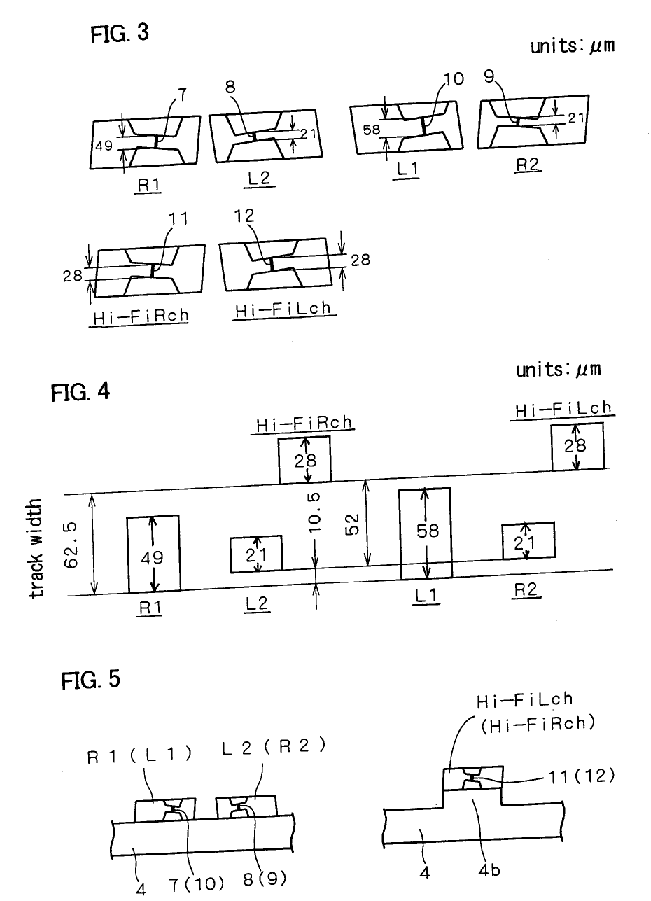

Referring now to the drawings, a preferred embodiment of rotary magnetic head of the invention is described specifically below. FIG. 1 shows a rotary magnetic head 1 of four-head hi-fi type incorporated in a magnetic recording and/or reproducing apparatus such as VCR (video cassette recorder), and comprising two pairs of video heads and one pair of audio heads, and FIG. 2 shows a common base for mounting two pairs of video heads R1, L2, R2, L1 and one pair of audio heads hi-fi Rch, hi-fi Lch on the rotary magnetic head 1. FIG. 3 shows cores for composing each head. The rotary magnetic head 1 comprises a stationary cylinder 2 and a rotary cylinder 3 of which outer circumference is the running surface of a magnetic tape, video heads R1, L2, R2, L1 for recording and/or reproducing video signals in a magnetic tape, audio heads hi-fi Rch, hi-fi Lch for recording and/or reproducing audio signals, and a common base 4 as a common base member for mounting these magnetic heads on the rotary cylinder.

The stationary cylinder 2 is affixed on the main body of magnetic recording and/or reproducing apparatus. The rotary cylinder 3 is rotatably supported above the stationary cylinder 2 across a specific interval by way of a shaft 4 and a bearing 5, and is rotated and driven by a rotary driving mechanism (not shown).

The right channel 1st video head R1 and left channel 1st video head L1 are mounted at 180-degree opposite positions across the center of rotation 4a of the common base 4. The right channel 2nd video head R2 is disposed adjacently to the video head L1, and the left channel 2nd video head L2 is disposed at a position 180 degrees opposite from the video head R2 across the center of rotation 4a. Thus, the video head R1 and video head L2 are disposed adjacently to each other. Each of channel, the 1st video head and the 2nd video head works alternately. The right channel audio head hi-fi Rch is disposed by deviating a specified angle of rotation from the video head R1, and the left channel audio head hi-fi Lch is disposed at a position 180 degrees opposite from the audio head hi-fi Rch across the center of rotation 4a. These audio heads hi-fi Rch, hi-fi Lch are disposed on a convex portion 4b of the common base 4, and their relative height positions with respect to the video heads are optimized.

The right channel magnetic heads R1, R2, hi-fi Rch, and left channel magnetic heads L1, L2, hi-fi Lch disposed mutually opposite to each other have gaps 7, 9, 11, and gaps 8, 10, 12, in mutually opposite directions as shown in FIG. 3, and thereby crosstalk is avoided between adjacent recording tracks of magnetic tape when recording and/or reproducing.

FIG. 4 shows the relative height configuration of magnetic heads and effective track width in an upside down relation. This height configuration is necessary for adequate recording and special reproduction by the magnetic heads. The gap of the video heads R2, L2 must be set lower than the gap of the video heads R1, L1 by 10.5 μm. The gap of the audio heads hi-fi Rch, hi-fi Lch must be set lower than the gap of the video heads R1, L1 by 62.5 μm. In FIG. 4, the numerical values shown in rectangles indicate the effective track width (unit: μm) of each head core.

FIG. 5 shows a mounting state of each magnetic head on the common base 4. The video head R1 and video head L2 forming gaps 7, 8 inclined in mutually opposite directions are adjacent to each other, and the video head R2 and video head L1 forming gaps 9, 10 inclined in mutually opposite directions are adjacent to each other, and they are all mounted on the common base 4. The audio head core hi-fi Rch and audio head core hi-fi head core Lch are mounted on the convex portion 4b, and the height positions are optimized.

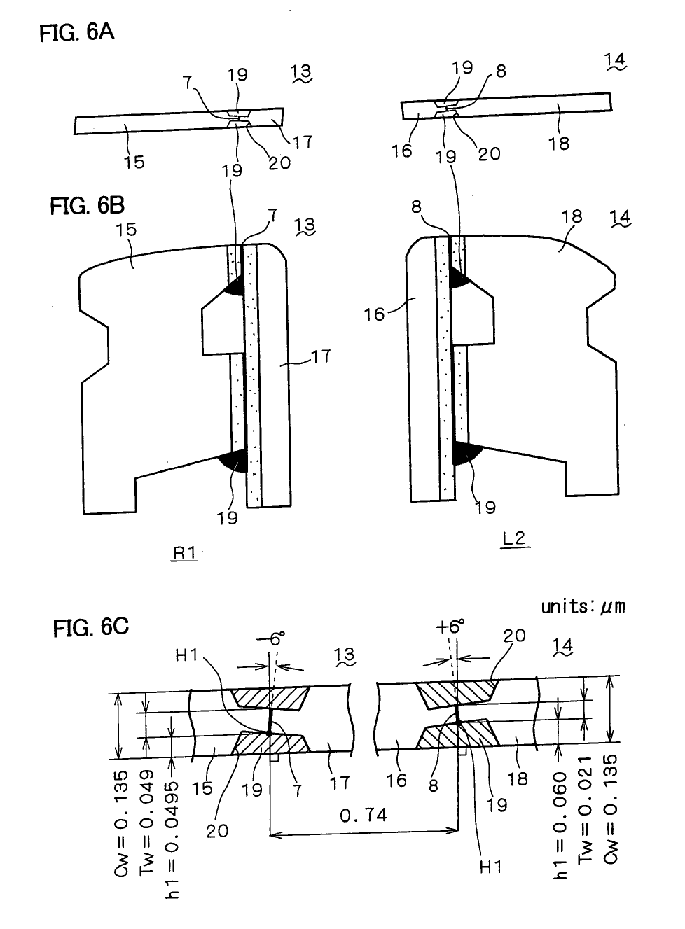

The structure of the video head is explained by referring to FIG. 6. Head cores 13, 14 of video heads R1, L2 are formed by adhering C-shape cores 15, 18 and I-shape cores 17, 16 by glass bonding, using glass 19. Near the adhesion surface of the C-shape cores 15, 18 and I-shape cores 17, 16, a groove 20 is processed for forming the gaps 7, 8 in a specified width dimension. The gaps 7, 8 are formed by sputtering, and their inclination angles (azimuth angles) are −6 degrees +/−10′ and +6 degrees +/−10′. Herein, in the video head core 13, the core width is Cw=0.135 mm, the effective track width is Tw=0.049 mm, and the height of the gap reference position H1 from the cutting-out surface (bottom) is h1=0.0495 mm. In the video head core 14, the core width is Cw=0.135 mm, the effective track width is Tw=0.021 mm, and the height of the gap reference position H1 from the cutting-out surface is h1=0.060 mm. When coils are wound around these head cores 13, 14, the video heads R1, L2 are completed. The video heads L1, R2 are also similarly composed.

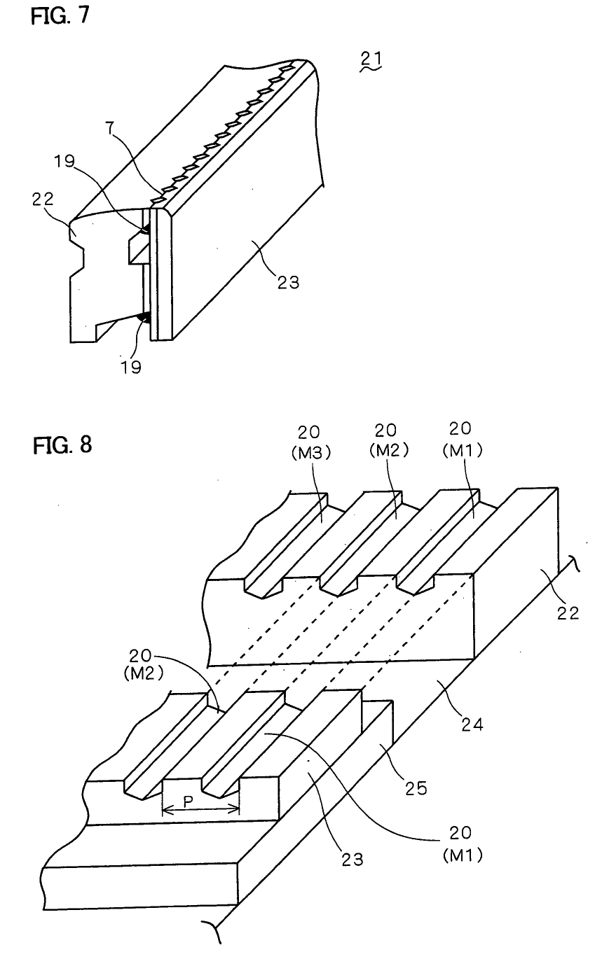

The video head core 13 is formed by cutting out a video core bar 21 linked like a bar as shown in FIG. 7, in an oblique direction at an azimuth angle (6 degrees +/−10′) of the gap 7, at a specified width Cw by means of a wire saw. The video head cores 14, 15, 16 are formed similarly. The audio head core is formed by cutting out an audio core bar in an oblique direction at an azimuth angle (for example, 30 degrees) of the gap, at a specified core width Cw.

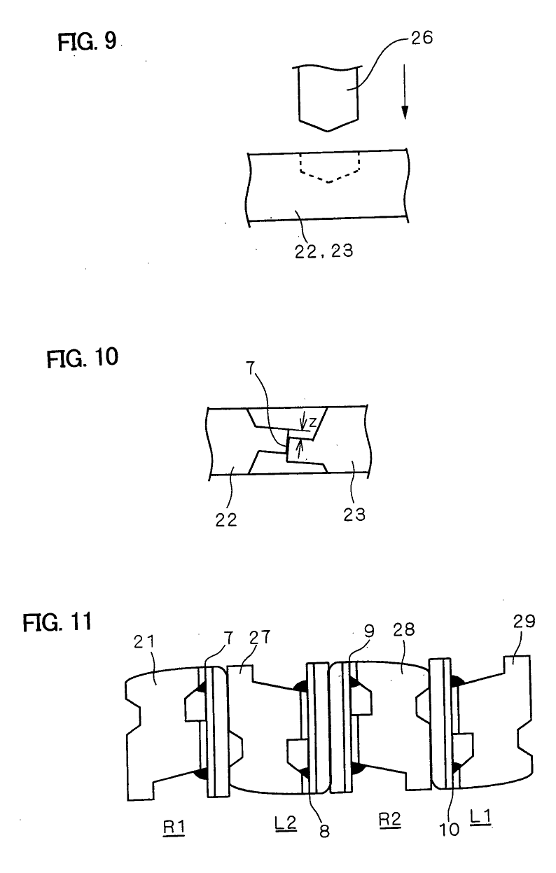

The forming process of the video core bar 21 is explained below by referring to FIG. 8 to FIG. 10. The C-shape core bar 22 and I-shape core bar 23 of the video core bar 21 are different in the width dimension, and hence when processing the groove 20, a jig 24 is used for correcting the width dimension. Herein, by placing a spacer 25 in the bottom of the I-shape core bar 23, the groove depth of the C-shape core bar 22 and the groove depth of the I-shape core bar 23 are equalized. The groove 20 is processed by pressing a grindstone 26, for example, as shown in FIG. 9 in an arrow direction by means of a groove processing machine. By setting adequately the pitch of automatic feeding of the groove processing machine, the groove 20 is processed at an accurate pitch. Therefore, when the C-shape core bar 22 and I-shape core bar 23 are adhered, there is almost no fluctuation of effective track width due to deviation Z of the joint faces of the C-shape core bar 22 and I-shape core bar 23 as shown in FIG. 10.

The forming process of the video core bar 21 is explained above, and the forming process of the audio core bar is nearly same as above except only the shape is different in the C-shape core and I-shape core, and its explanation is omitted.

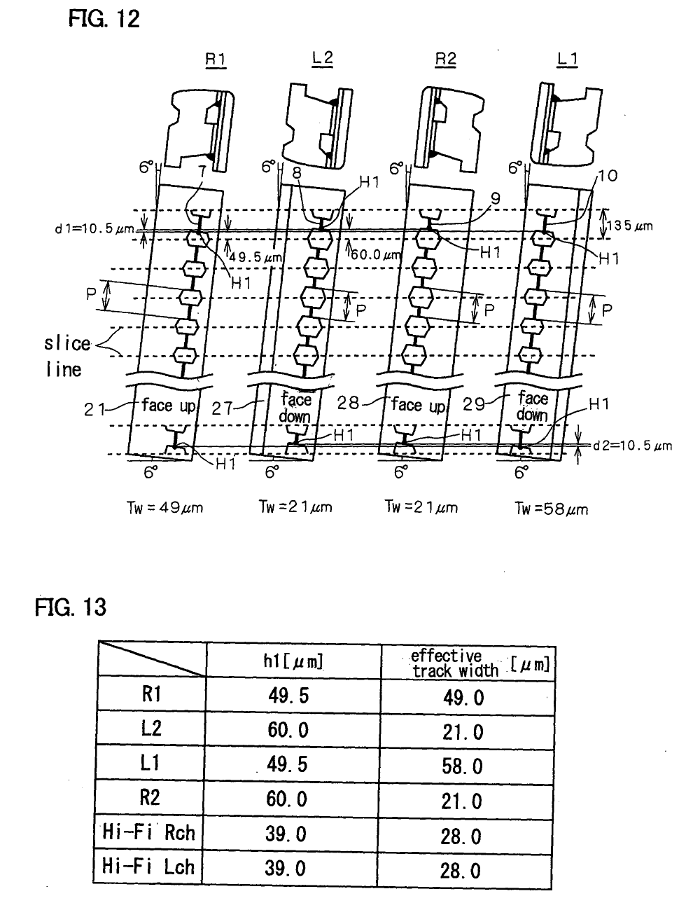

The forming process of the video head core is explained by referring to FIG. 11 to FIG. 13. The core bar 21 for video head R1 and the core bar 27 for video head L2 are fixed face up and down (R1 face up, L2 face down), and in parallel thereto, further, the core bar 28 for video head L1 and the core bar 29 for video head R2 are fixed face up and down (R2 face up, L1 face down). These core bars are inclined by 6 degrees to the slice line as the reference line for cutting out, and cut in a slice of 135 μm in thickness by a wire saw. At this time, as shown in FIG. 12, the core bar 21 and core bar 27 are fixed in the bar cutting jig so that the difference of H1 of gap 7 and H1 of gap 8 may be d1=d2=10.5 μm, and the core bar 28 and core bar 29 are fixed so that the difference of H1 of gap 9 and H1 of gap 10 may be d1=d2=10.5 μm. The core bar R1 and core bar L1 are fixed at the same height position. The core bars are thus fixed, and are sequentially cut out from the end side of any one of the core bars, along the slice line of 49.5 μm downward from Hi of the core bar R1 and core bar L1 (60.0 μm from H1 of the core bar L2 and core bar R2).

The video head R1 and video head L2 differ in the effective track width TW. The width of the grooves 20 formed in the C-shape core bar 22 and I-shape core bar is the same the pitch P of the grooves is hardly deviated. Therefore, by slicing sequentially by determining the pitch from the dimensional relation shown in FIG. 12, the difference of the reference height position H1 of gap of the video head R1 and reference height position H1 of gap of the video head L2 may be adjusted to d1=d2=10.5 μm. It is the same in the video heads R2, L1.

Thus, the forming process of the video head core is explained, and the forming process of the audio head core is nearly the same, except that two audio core bars are arranged and fixed to cut out a pair of audio head cores. The audio core bars are arranged so that the slice line may be positioned lower by 39.0 μm from H1 of the audio heads hi-fi Rch, hi-fi Lch. The heights h1 and Tw of the head cores of the video heads R1, L2, L1, R2 and the head cores of the audio heads hi-fi Rch, hi-fi Lch being thus cut out are the dimensions as shown in FIG. 13.

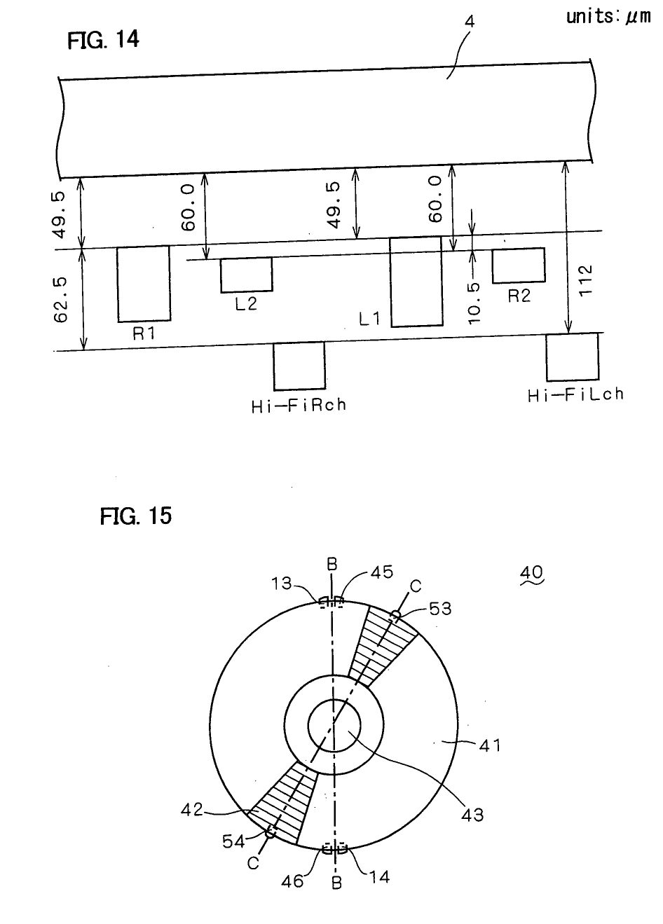

The relative height position relation of the magnetic heads is explained. The video heads R1, L2, L1, R2, and audio heads hi-fi Rch, hi-fi Lch are adjusted so that the height position of each gap from the common base 4 may be in the relation as shown in FIG. 14, and the heads are adhered to the common base. According to FIG. 14, the height of the gap of the video heads R1, L1 from the common base 4 is 49.5 μm, and the height of the gap of the video heads R2, L2 from the common base 4 is 60.0 μm. These gap heights coincide with the height h1 of each video head core fabricated in the above method. Therefore, by adhering the video head cores R1, L2, L1, R2 to the common base so as not to be cleared from the adhesion reference plane, the video head cores R1, L2, L1, R2 can be mounted on the common base at an accurate height position without requiring adjustment of the height position.

On the other hand, the height of gap of the audio head cores hi-fi Rch, hi-fi Lch from the common base 4 is 49.5+62.5=112.0 μm. Since the height of the audio head cores hi-fi Rch, hi-fi Lch is h1=39.0 μm, the cutting-out surface of the audio head cores hi-fi Rch, hi-fi Lch must be projected downward by 112.0−39.0=73.0 μm from the adhesion reference plane of the common base. Therefore, by adhering the video head cores R1, L2, L1, R2 to the adhesion reference plane of the common base and projecting the audio head cores hi-fi Rch, hi-fi Lch downward from the adhesion reference plane by 73.0 μm, the relation of the height position of the head cores is obtained as shown in FIG. 13.

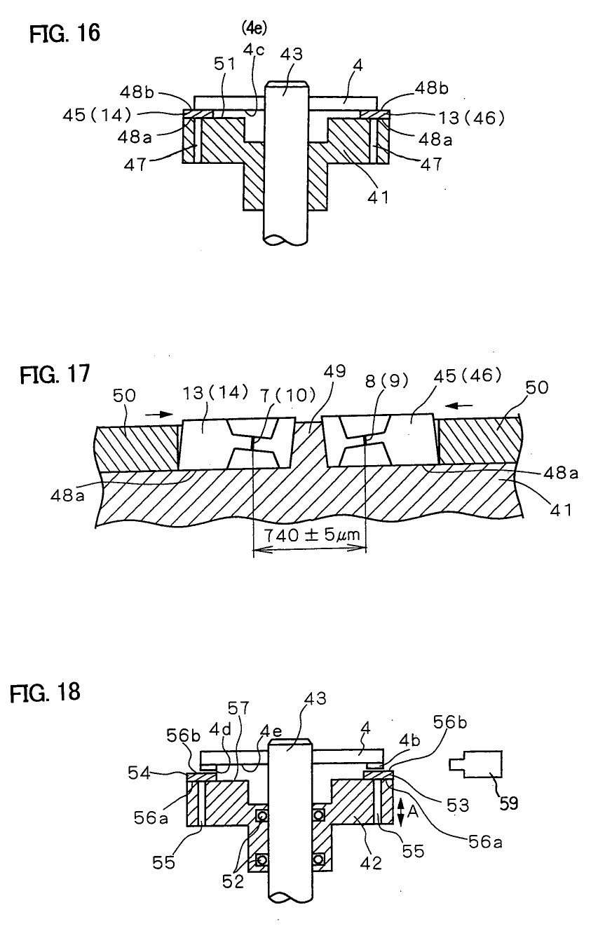

The adjusting process of height position of magnetic heads is explained by referring to FIG. 15 to FIG. 18. The height position of each magnetic head is adjusted by using a head core fixing jig 40. The head core fixing jig 40 includes a video head core fixing jig 41, an audio head core fixing jig 42, and a support shaft 43. The video head core fixing jig 41 is fixed on the support shaft 43 as shown in FIG. 16, and temporarily fixes the video head cores 13, 14, 45, 46. The video head cores 13, 14, 45, 46 are sucked from suction holes 47 disposed at positions corresponding to the mounting positions of the cores, and one cutting-out surface 48a is sucked by air, and other cutting-out surface 48b is directed upward, and they are held in this state. At this time, since the winding is not wound on each core yet, the cores are held fly by the video head core fixing jig 41 nearly on the whole surface of the cutting-out surface 48a (bottom). In the mounting portion of the video head cores 13, 14, 45, 46, as shown in FIG. 17, there are a column 49 as guide for positioning the video head cores 13, 14, 45, 46, and a pushing mechanism 50 for pushing the video head cores 13, 14, 45, 46 to the column 49 (in arrow direction). By the column 49 and the pushing mechanism 50, the adjacent video head cores 13, 45 (14, 46) are positioned so that the interval of the gaps 7, 8 (10, 9) may be 740+/−5 μm. The mounting face 51 of the video head core is formed parallel to the video head core adhering face 4c of the common base 4 when adhering the head core.

The audio head core fixing jig 42 is supported by the support shaft 43 through a bearing 52 as shown in FIG. 18, and is freely movable in a perpendicular direction A (axial direction of support shaft) to the cutting-out surfaces 48a, 48b of the video head core, and temporarily fixes the audio head cores 53, 54. The audio head cores 53, 54 are held in the same state as mentioned above, that is, one cutting-out surface 56a is sucked by air from suction holes 57, while the other cutting-out surface 56b is directed upward. At this time, since the winding is not wound on each core yet, the cores are held firmly by the audio head core fixing jig 42 nearly on the whole surface of the cutting-out surface 48a (bottom). The mounting portion 57 of the audio head cores is formed parallel to the audio head core adhering face 4d of the common base when adhering the magnetic head core. The height position of the audio head cores 53, 54 is adjusted by moving the audio head core fixing jig 42 up and down while observing the image taken by a television camera with a microscope 59. By this move of the audio head core fixing jig 42, the cutting-out surface 56 of the audio head cores hi-fi Rch, hi-fi Lch is positioned lower by 73 μm from the adhesion reference plane 4e of the common base 4. At this time, the audio head cores hi-fi Rch, hi-fi Lch are cut out simultaneously when positioned in the method above, and the height position of the gap from the cutting-out surface 56b is nearly the same. Therefore, the pair of audio head cores 53, 54 are simultaneously adjusted in the height position. In this process, adjustment of relative height position of the video head cores 13, 14, 45, 46 and audio head cores 53, 54 is completed.

The head adhesion process is explained. The common base 4 is mounted from above the head core fixing jig 40, and the video head cores 13, 14, 45, 46, and audio head cores 53, 54 are adhered to the common base 4 by means of resin (adhesive), and thus the magnetic heads are mounted on the common base 4 while the relative height position of the gaps 7, 8, 9, 10, 11, 12 is adjusted. At this time, the common base 4 is positioned by the support shaft 43, and the distance from the center of rotation 4a of the common base 4 to each magnetic head is nearly the same.

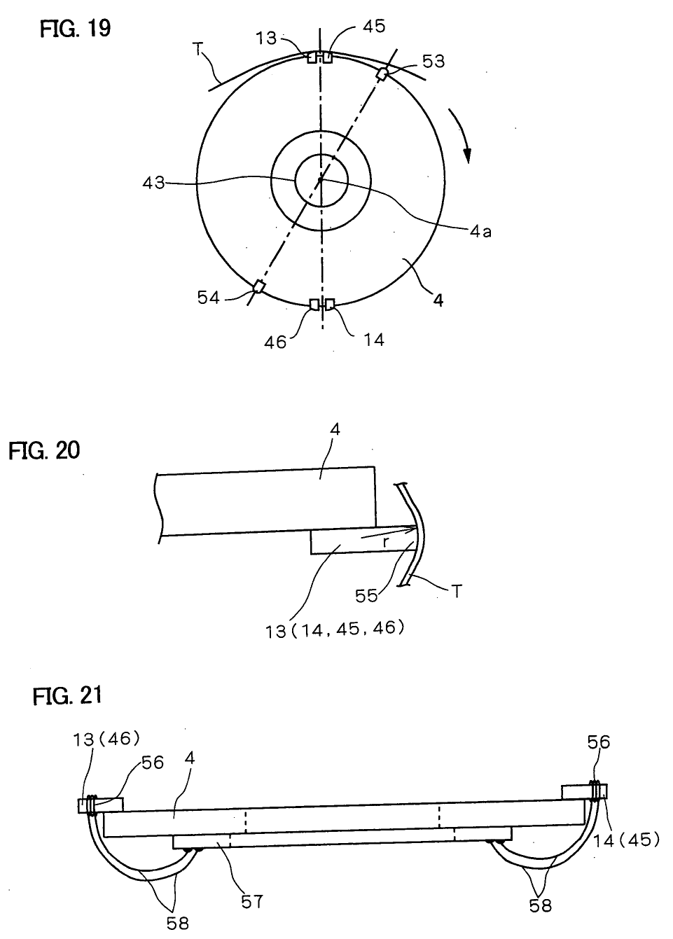

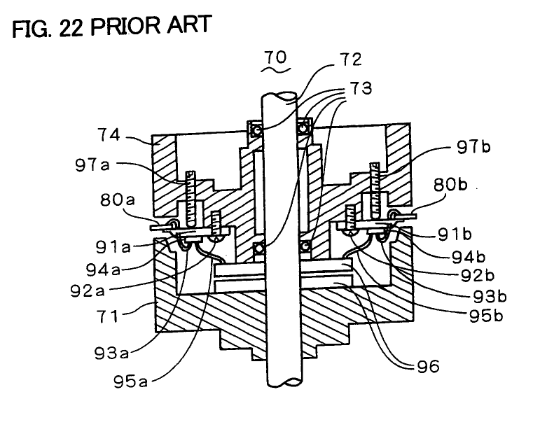

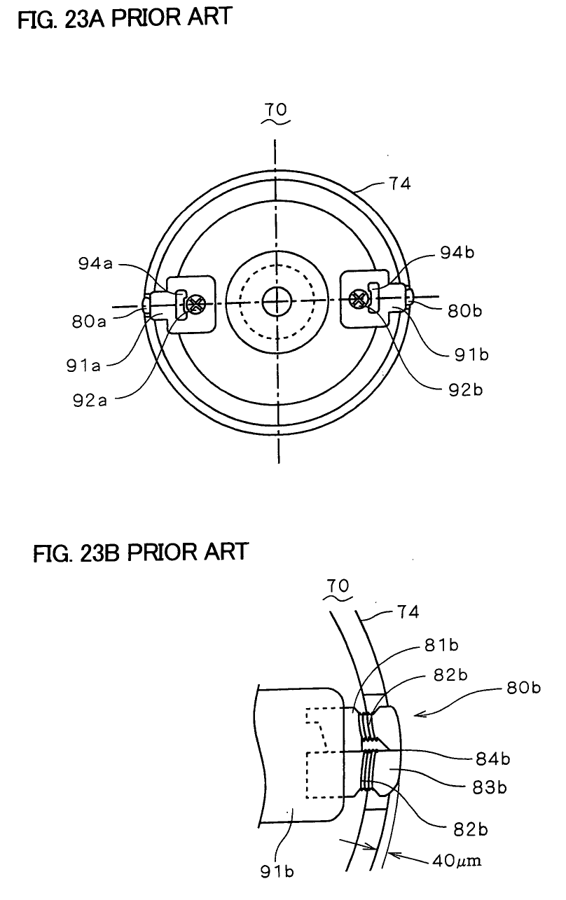

The core polishing process is explained. The leading ends of the head cores 13, 14, 45, 46, 53, 54 adhered to the common base 4 are polished by a polishing tape T (polisher) to a specified dimension as shown in FIG. 19 and FIG. 20. In the polishing process of the head core leading ends, while rotating the common base 4 in the direction of arrow, the polishing tape T is pressed against the leading ends of the head cores 13, 14, 45, 46. By this core polishing process, the leading ends of the head cores 13, 14, 45, 46 are polished to a specified radius of curvature of r. The distance from the center of rotation 4a of the common base 4 to the leading ends 55 of all head cores is exactly the same. FIG. 20 shows only the video head cores, but it is the same in the audio head cores 53, 54.

The base adhering process is explained by referring to FIG. 21. A coil winding 56 of a specified number of turns is wound on the head cores 13, 14, 45, 46 after polishing of the leading ends 55 in the core polishing process. Then a printed circuit board is adhered to the common base 4, and the lead portion 58 of the coil winding 56 is soldered. Thus wired common base 4 is adhered and fixed to the rotary cylinder 3. At this time, the rotary cylinder 3 and common base 4 are positioned in the cylinder rotating direction by matching the position of the magnetic head in the notch for projection of magnetic head provided in the rotary cylinder 3. Or protrusion or other positioning means may be separately provided in the rotary cylinder 3. FIG. 21 shows only the video head cores 13, 14, 45, 46, but it is the same in the audio head cores 53, 54.

According to this mounting method of the magnetic heads, by optimizing the height positions of the two pairs of video head cores 13, 14, 45, 46 and one pair of audio head cores 53, 54 and adhering to the common base 4, and adhering this common base 4 to the rotary cylinder 3, the head cores are mounted on the rotary cylinder 3. As a result, the plural mounting bases, mounting screws for mounting base, and height adjusting screws which were required in the prior can be omitted, and the assembling process of the rotary cylinder is simplified, and the manufacturing cost of the rotary cylinder is saved. Moreover, this method does not require drilling or tapping in the cylinder for fixing the mounting screws and height adjusting screws, and the assembling process of the rotary cylinder can be simplified, and the manufacturing cost of the rotary cylinder can be further curtailed.

Still more, since the leading ends of the head cores are polished simultaneously and the distance from the center of rotation of the mounting base to the leading ends of all head cores after polishing is all the same, the adjustment of protruding dimension of the head cores from the cylinder surface required in the conventional mounting method of magnetic head is no longer needed, and the assembling process of the rotary cylinder can be further simplified, and the manufacturing cost of the rotary cylinder is much more saved.

The magnetic head core mounting surface of the head core fixing jig is formed parallel to the video head core adhering face 4c and audio head core adhering face 4d of the common base when adhering the head cores, and therefore the head cores are held accurately, and the adhesion precision of the head cores is enhanced.

The invention is not limited to the illustrated embodiment alone, but may be modified in various forms and it may be applied, for example, in a VCR of two-head type having a pair of video heads, or four-head type having two pairs of video heads. In such a case, by omitting the mounting base, mounting screws for mounting base, and height adjusting screws, the manufacturing cost of the rotary cylinder can be saved. Instead of the video core bars, other video core bars may be fabricated by forming the direction of the junction in a mutually reverse direction to the extending direction of the core bar, and they may be directed the same in the vertical direction of the image and cut out simultaneously by matching the corresponding positions of the both gaps. In such a method, the head cores having gaps in reverse directions and appropriate in the height hi of the reference position Hi of the gaps can be fabricated. The same can be applied to the audio core bars.

This application is based of Japanese Patent Application No. 2002-258185 filed in Japan dated Sep. 3, 2002, the contents of which are hereby incorporated by references.

What is claimed is:

1. A method of mounting magnetic heads on a rotary cylinder, in a rotary magnetic head comprising a rotary cylinder, a mounting base mounted on this rotary cylinder, and magnetic heads for right channel and left channel provided at 180-degree opposite positions across the center of rotation on the mounting base, comprising:
a core bar fabricating step of forming bar-shaped core bars having gaps for generating magnetic flux,
a core fabricating step of forming head cores by fixing two core bars formed in said core bar fabricating step as one pair by arranging the two core bars in an oblique direction with the corresponding positions of the gaps matched at said specified angle, and cutting out these core bars in a thickness unit of one head core in an oblique direction at said specified angle,
a head core holding step of matching the relative height positions of the gaps by holding the head cores fabricated at said core fabricating step in a core fixing jig,
a head mounting step of mounting said head cores held at said head core holding step on a mounting base common to both head cores, and
a base mounting step of mounting said mounting base on which said head cores are mounted at said head mounting step on said rotary cylinder.

2. The method of mounting magnetic heads on a rotary cylinder according to claim 1, further comprising:
a core polishing step of polishing the leading ends of the head cores by pressing a polisher to the leading ends of the head cores while rotating said mounting base on which said head cores are mounted at said head mounting step.

3. A method of mounting said video heads and audio heads on a rotary cylinder, in a magnetic head comprising a rotary cylinder, a mounting base mounted on this rotary cylinder, each pair of video heads for right channel and left channel provided at 180-degree opposite positions across the center of rotation on said mounting base, and each pair of audio heads for right channel and left channel provided at 180-degree opposite positions across the center of rotation on the mounting base, comprising:
a core bar fabricating step of forming video core bars and audio core bars having gaps between them by adhering bar-shaped C-shape core bar and I-shape core bar,
a video core fabricating step of forming two pairs of video head cores by fixing two video core bars formed in said core bar fabricating step as one pair by arranging the two pairs, with the two video core bars face up and down, in an oblique direction with the corresponding positions of the gaps matched at said specified angle, and cutting out these two pairs of video core bars in a thickness unit of one video head core in an oblique direction at the specified angle,
an audio core fabricating step of forming one pair of audio head cores by fixing two audio core bars formed in said core bar fabricating step as one pair, with the two audio core bars face up and down, in an oblique direction with the corresponding positions of the gaps matched at said specified angle, and cutting out the pair of audio core bars in a thickness unit of one audio head core in an oblique direction at the specified angle,
a core height adjusting step of adjusting the relative height positions of gap of said video head cores and gap of said audio head cores, by holding the two pairs of video magnetic head cored formed at said video core fabricating step by a video head core fixing jig, holding the pair of audio head cores formed at said audio core fabricating step by an audio head core fixing jig slidable in a direction perpendicular to the cutting-out surface of said video head cores, and sliding the audio head core fixing jig,
a head adhering step of adhering said video head cores and said audio head cores of which relative height positions of gaps are adjusted at said core height adjusting step, on a mounting base common to the head cores,
a core polishing step of polishing the leading ends of the head cores by pressing a polisher to the leading ends of the head cores while rotating the mounting base on which said video head cores and said audio head cores are adhered at said head adhering step, and
a base adhering step of adhering said mounting base on said rotary cylinder after winding a coil winding on each said head core polished at said core polishing step.

4. A rotary magnetic head for VCR comprising:
a rotary cylinder,
a mounting base adhered to said rotary cylinder,
each pair of video heads for right channel and left channel formed at 180-degree opposite positions across the center of rotation of said mounting base,
each pair of audio heads for right channel and left channel formed at 180-degree opposite positions across the center of rotation of said mounting base, and
a rotary cylinder on which said video heads and audio heads are mounted by way of said mounting base,
wherein said video heads and audio heads respectively form a gap between them by adhering C-shape core and I-shape core, and
video head cores and audio head cores are adhered to the mounting base common to the head cores, with the relative height positions of gaps being adjusted.
